(19) United States
(12) Patent Application Publication
(10) Pub. No.: US 2003/0224686 A1
(43) Pub. Date: Dec. 4, 2003

(54) Base web including hydroentangled air-laid fibers

(76) Inventor: Jens Ole Brochner Andersen, Skanderborg (DK)

Correspondence Address: WINSTON & STRAWN, PATENT DEPARTMENT, 1400 L STREET, N.W., WASHINGTON, DC, 20005-3502, US

(21) Appl. No.: 10/463,507

(22) Filed: Jun. 16, 2003

Related U.S. Application Data
(63) Continuation of application No. PCT/DK01/00355, filed on May 23, 2001.

(51) Int. Cl. D04H 1/00; D04H 3/00; D04H 5/00; B32B 5/26

(52) U.S. Cl. 442/361; 442/408; 442/381; 442/409; 442/394

(57) ABSTRACT

A base web is comprising a base web consisting of synthetic fibers, air-laid cellulose fibers or synthetic fibers or cellulose fibers mixed with synthetic fibers air-laid in form of fluff on the base web, and a structure obtained by hydroentangling the fluff on the base web. The weight of the web is between 80 and 2000 g/m². The heavy-duty webs of the invention can advantageously be used for producing e.g. corrugated board and heat- and/or sound-insulating materials.

### CROSS-REFERENCE TO RELATED APPLICATIONS

This application is a continuation of International application PCT/DK00/00355 filed May 23, 2001, which is a continuation of International application PCT/DK00/00712 filed Dec. 19, 2000, the entire contents of each of which are expressly incorporated herein by reference thereto

### BACKGROUND ART

The invention relates to a web comprising a base web consisting at least mainly of synthetic fibers, air-laid cellulose fibers or synthetic fibers or cellulose fibers mixed with synthetic fibers air-laid in form of fluff on the base web, and a structure obtained by hydroentangling the fluff on the base web.

During the hydroentangling process, jets of water are, under the influence of a pressure as high as e.g., 100 bar, directed through a number of nozzles towards the fiber fluff on the base web. The base web has to be strong enough to withstand the heavy load from the water jets and is therefore normally produced of synthetic fibers.

In some cases the base web can be a spunbonded/meltblown (SMMS) web, but usually it is formed of carded fibers which are hydroentangled and dried before being used as base for the air-laid fiber fluff during the hydroentangling of this.

Conventionally such webs have a weight of between 20 and 80 g/m² and are to a great extend used for manufacturing disposable non-woven products as e.g. feminine hygiene articles, incontinence articles, diapers, napkins, wipes and towels. There is a need for improved webs, however, and these are provided by the present invention.

### SUMMARY OF THE INVENTION

The invention relates to a web comprising a base web that mainly includes synthetic fibers, and an air-laid fluff of cellulose fibers, synthetic fibers or mixtures thereof in a coherent web that has a hydroentangled structure. Advantageously, the web has a weight of between 80 and 2000 g/m². The air-laid fluff preferably comprises a mixture of synthetic fibers and cellulose fibers, wherein the synthetic fibers are bonded by heat treatment both to the cellulose fibers and to each other.

If desired, the web can have a structure obtained by steam-treating the web for binding dust thereon. Other features can also be provided. For example, any of the following can be provided on at least one side of the web: a hot-melt layer of plastic, at least one non-woven web, at least one layer of melt blown fibers, bicomponent fibers, or a combination thereof, at least one carded web, a plastic film, or a binder. Also, the web can be calendered.

### DETAILED DESCRIPTION OF THE PREFERRED EMBODIMENTS

The webs according to the invention are preferably heavy-duty webs having a weight of between 80 and 2000 g/m². In addition to the base web and the hydroentangled fluff, different kinds of layers can be laminated thereto. As an example of such other layers can be mentioned a hot-melted layer of a plastic on at least one side of the hydroentangled web, and at least one nonwoven web on the melted plastic.

In another example the other layers comprise at least one layer of melt blown fibers (SMMS) or bicomponent fibers and/or a combination of these on at least one side of the web.

In a third example the other layers comprise at least one carded web on at least one side of the web.

In a forth example the other layers comprise at least one carded web on at least one side of the web, and a film of e.g. a plastic on at least one side of the web.

Heavy duty webs of the kind named above are usually calendered and can advantageously be used for producing e.g. corrugated board and heat—and/or sound insulating materials.

The processes and equipment for making such webs are generally known in the art. Reference can be made to a method and apparatus that is described in a US continuation application of International application PCT/DK00/00354 which is being filed on even date herewith, the content of which is expressly incorporated herein by reference thereto.

What is claimed is:

1. A web comprising a base web that mainly includes synthetic fibers, and an air-laid fluff of cellulose fibers, synthetic fibers or mixtures thereof in a coherent web that has a hydroentangled structure, with the web having a weight of between 80 and 2000 g/m².

2. The web according to claim 1, where the base web consists essentially of synthetic fibers.

3. The web according to claim 1, where the air-laid fluff comprises a mixture of synthetic fibers and cellulose fibers, wherein the synthetic fibers are bonded by heat treatment both to the cellulose fibers and to each other.

4. The web according to claim 1, which has a structure obtained by steam-treating the web for binding dust thereon.

5. The web according to claim 1 further comprising a hot-melt layer of plastic on at least one side of the web, and at least one non-woven web on at least one side of the web.

6. The web according to claim 5 further comprising at least one non-woven web on at least one side of the web.

7. The web according to claim 1 further comprising at least one nonwoven web on at least one side of the web.

8. The web according to claim 1 further comprising at least one layer of melt blown fibers, bicomponent fibers, or a combination thereof on at least one side of the web.

9. The web according to claim 1 further comprising at least one carded web on at least one side of the web.

10. The web according to claim 9 further comprising a plastic film on at least one side of the web.

11. The web according to claim 1 further comprising a plastic film on at least one side of the web.

12. The web according to claim 1 further comprising a binder on at least one side of the web.

13. The web according to claim 1, which is calendered.
